(19) United States
(12) Patent Application Publication
(10) Pub. No.: US 2007/0241926 A1
(43) Pub. Date: Oct. 18, 2007

(54) Method of quickly finding a network device in a home network using infrared sensor

(76) Inventors: Hung-Yi Chen, Hsin-Chu City (TW); Wei-Nan William Tseng, Taipei City (TW); Cheng-Te Tseng, Taipei City (TW); Yen-Ju Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/379,220

(22) Filed: Apr. 18, 2006

(51) Int. Cl. G06F 15/177

(52) U.S. Cl. 340/825.22; 340/825; 370/254; 340/825.72; 398/106; 709/220; 709/227; 340/3.7

(57) ABSTRACT

A method of controlling a plurality of network devices in a network with a control point includes registering the plurality of network devices with the control point through the network, providing each of the plurality of network devices with an infrared (IR) sensor, pointing an IR transmitter of the control point at a selected network device, activating the IR transmitter of the control point to emit an IR beam at the IR sensor of the selected network device, establishing a control link between the control point and the selected network device through the network in response to the IR sensor of the selected network device receiving the IR beam from the control point, and issuing a control signal from the control point to the selected network device through the network using the established control link so that the selected network device performs a specified action corresponding to the control signal.

### BACKGROUND OF THE INVENTION

1. Field of the Invention

The present invention relates to controlling devices in a home network, and more specifically, to a method of utilizing an infrared transmitter on a control point and an infrared sensor a selected network device to establish a connection between the control point and the selected network device.

2. Description of the Prior Art

When more and more devices exist in the house, it is reasonable to attempt to connect all the devices. In this way, the user can easily use one controller to operate the devices. In the home network, Universal Plug and Play (UPnP™) technology is employed to link the devices. It is an open networking architecture that employs TCP/IP and other Internet technologies, such as UDP, HTTP, SSDP, SOAP, GENA, and XML, to enable a device to dynamically join a network, obtain an IP address, convey its capabilities, and learning about the presence and capabilities of other devices with zero configuration needed. Devices can subsequently communicate with each other directly, thereby further enabling peer to peer networking.

Within UPnP™, a control point is a controller capable of discovering and controlling other devices. Discovery is the first step in UPnP™ networking. When a device is added to the network, the UPnP™ discovery protocol allows that device to advertise its services to control points on the network by multicasting a number of discovery messages. While a device is removed from the network, it should, if possible, multicast a number of messages revoking its earlier announcements, effectively declaring that its services will no longer be available.

In the home network, each active device is represented by a unique name. As the number of devices increase, it is not always easy to assign the devices names that are easy to remember. The name used on the network may not make sense to the users, especially when multiple devices of the same type exist on the network. The lack of a clear naming convention may lead users to become confused when they need to control devices on the network. Therefore, users may be forced to use trial and error to find the selected device they wish to control using the control point. This method is inconvenient since it may take several tries to locate the selected device.

### SUMMARY OF THE INVENTION

It is therefore an objective of the claimed invention to provide a method of controlling network devices in order to solve the above-mentioned problems.

According to an embodiment of the claimed invention, a method of controlling a plurality of network devices in a network with a control point is presented. The method includes registering the plurality of network devices with the control point through the network, providing each of the plurality of network devices with an infrared (IR) sensor, pointing an IR transmitter of the control point at a selected network device, activating the IR transmitter of the control point to emit an IR beam at the IR sensor of the selected network device, establishing a control link between the control point and the selected network device through the network in response to the IR sensor of the selected network device receiving the IR beam from the control point, and issuing a control signal from the control point to the selected network device through the network using the established control link so that the selected network device performs a specified action corresponding to the control signal.

According to another embodiment of the claimed invention, a home network system used in a network includes a plurality of network devices each comprising an infrared (IR) sensor, the network devices being connected to the network. The home network system also includes a control point for controlling the plurality of network devices, the plurality of network devices being registered with the control point through the network. The control point includes an IR transmitter for emitting an IR beam at an IR sensor of a selected network device from the plurality of network devices and a control interface for issuing a control signal to the selected network device through the network after a control link between the control point and the selected network device has been established through the network in response to the IR sensor of the selected network device receiving the IR beam from the control point. In response to receiving the control signal from the control point, the selected network device performs a specified action corresponding to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a home network system according to the present invention.

FIG. 2 shows the home network system after the control point has established a control link with the selected device.

### DETAILED DESCRIPTION

The present invention overcomes the limitations of the prior art by allowing the user to point the control point at a device he wishes to control so that the user can quickly and easily use the control point to indicate which device has been selected.

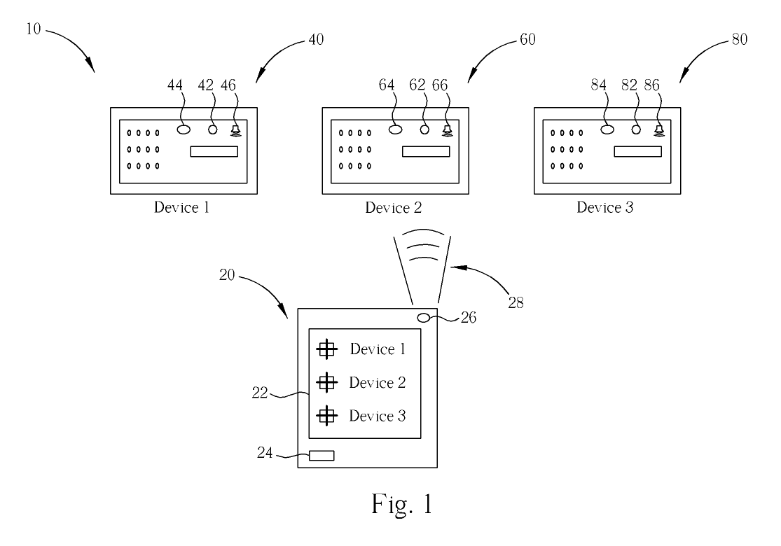

Please refer to FIG. 1. FIG. 1 is a block diagram of a home network system 10 according to the present invention. The home network system 10 contains a control point 20 used for controlling a plurality of devices 40, 60, 80 connected to a home network. The control point 20 contains a user interface 22 for allowing a user to control and view information about the devices 40, 60, 80. In addition, the control point 20 contains a query button 24 for activating an infrared (IR) transmitter 26 of the control point 20 to emit an IR beam 28. For simplicity, each of the devices 40, 60, 80 is shown as being identical, although this is not required.

The present invention is useful for aiding a user in selecting one device out of many in the home network when it is difficult to ascertain what devices correspond to names given to them on the home network. The devices 40, 60, 80 each include an IR sensor 42, 62, 82 for sensing the IR beam 28 emitted from the IR transmitter 26 of the control point 20. In addition, the devices 40, 60, 80 contain light emitting diodes (LEDs) 44, 64, 84 and speakers 46, 66, 86 for alerting a user that the corresponding IR sensor 42, 62, 82 has received the IR beam 28 from the IR transmitter 26. Other forms of indicators can also be used besides speakers and LEDs, so long as the selected device is able to alert the user to the fact that the device has been selected.

The control point 20 initially searches all the devices 40, 60, 80 that are active on the network. After discovery, the control point 20 may get information about what functions and services each device 40, 60, 80 can perform. Consider the scenario: several devices 40, 60, 80 are around the user, and the user wants to control device 60. Although each of the devices 40, 60, 80 has a corresponding name shown on the user interface 22 of the control point 20, such name doesn't make sense to the user.

As shown in FIG. 1, the control point 20 is pointed toward device 60, and the IR transmitter 26 emits the IR beam 28 in the direction of the IR sensor 62 when the user presses the query button 24 on the control point 20. If the device 60 is in the receiving range of the IR beam 28, the IR sensor 62 of the device 60 will detect the signal and respond by playing a sound from the speaker 66 or by emitting light from the LED 64. This is an indication that the control point 20 has established a control link with the device 60.

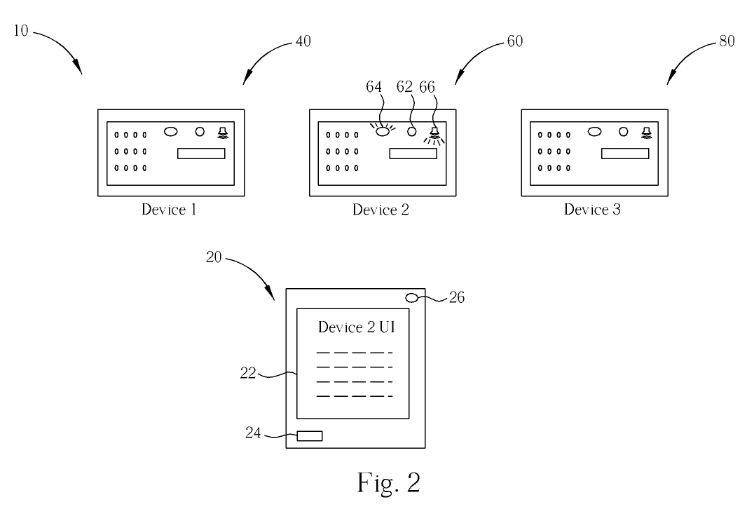

Please refer to FIG. 1 and FIG. 2. Before the control point 20 establishes the control link with the device 60, the user interface 22 of the control point 20 lists all of the available devices 40, 60, 80 in the home network system 10. FIG. 2 shows the home network system 10 after the control point 20 has established the control link with the selected device 60. When the IR sensor 62 of the device 60 receives the IR beam 28, the device 60 will inform the control point 20 through the home network using UPnP™ technology. At this point, the user interface 22 only lists the device 60 since the control point 20 has selected it by using the emitted IR beam 28. Once the device 60 has been selected, the user can control the device using the user interface 22 of the control point 20 to send control signals through the home network.

When one of the devices 40, 60, 80 is removed from the home network, it not only uses UPnP™ technology to inform the control point 20, but it can also use the corresponding LED 44, 64, 84 or speaker 46, 66, 86 to inform the user. At the same time, the user interface 22 of the control point 20 will no longer list the removed device.

In summary, the present invention provides a way to easily use the control point of a home network to select a network device. An IR transmitter is pointed at an IR sensor on the selected device to establish a control link between the control point and the selected device. Thereafter, the control point can issue commands to the selected device through the home network as usual.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a plurality of network devices in a network with a control point, the method comprising:
registering the plurality of network devices with the control point through the network;
providing each of the plurality of network devices with an infrared (IR) sensor;
pointing an IR transmitter of the control point at a selected network device;
activating the IR transmitter of the control point to emit an IR beam at the IR sensor of the selected network device;
establishing a control link between the control point and the selected network device through the network in response to the IR sensor of the selected network device receiving the IR beam from the control point; and
issuing a control signal from the control point to the selected network device through the network using the established control link so that the selected network device performs a specified action corresponding to the control signal.

2. The method of claim 1, further comprising:
providing each network device with an indicator unit; and
utilizing the indicator unit of the selected network device to notify a user of the control point that the IR sensor of the selected network device has received the IR beam from the control point.

3. The method of claim 2, wherein the indicator unit is a speaker for emitting a sound when the IR sensor of the selected network device has received the IR beam from the control point.

4. The method of claim 2, wherein the indicator unit is a light emitting device for emitting light when the IR sensor of the selected network device has received the IR beam from the control point.

5. A home network system used in a network, comprising:
a plurality of network devices each comprising an infrared (IR) sensor, the network devices being connected to the network; and
a control point for controlling the plurality of network devices, the plurality of network devices being registered with the control point through the network, the control point comprising:
an IR transmitter for emitting an IR beam at an IR sensor of a selected network device from the plurality of network devices; and
a control interface for issuing a control signal to the selected network device through the network after a control link between the control point and the selected network device has been established through the network in response to the IR sensor of the selected network device receiving the IR beam from the control point;
wherein the selected network device performs a specified action corresponding to the control signal in response to receiving the control signal from the control point.

6. The system of claim 5, wherein each network device further comprises an indicator unit for notifying a user of the control point that the IR sensor of the selected network device has received the IR beam from the control point.

7. The system of claim 6, wherein the indicator unit is a speaker for emitting a sound when the IR sensor of the selected network device has received the IR beam from the control point.

8. The system of claim 6, wherein the indicator unit is a light emitting device for emitting light when the IR sensor of the selected network device has received the IR beam from the control point.
